(19) United States
(12) Patent Application Publication
(10) Pub. No.: US 2023/0401459 A1
(43) Pub. Date: Dec. 14, 2023

(54) IMAGE INFERENCE METHOD, COMPUTER DEVICE, AND STORAGE MEDIUM

(71) Applicant: HON HAI PRECISION INDUSTRY CO., LTD., New Taipei (TW)

(72) Inventors: YUNG-CHING CHIEN, New Taipei (TW); WEN-YIN WANG, New Taipei (TW)

(21) Appl. No.: 17/854,333

(22) Filed: Jun. 30, 2022

(30) Foreign Application Priority Data
Jun. 9, 2022 (CN) 202210652112.X

(51) Int. Cl. G06N 5/02

(52) U.S. Cl. CPC G06N 5/022

(57) ABSTRACT

An image inference method is provided by the present disclosure. The method includes determining a target collocation scheme for an image according to an inference request and a preset weight table, the target collocation scheme including a hardware accelerator in an idle state and an estimated time duration of inferring the image. A usage state of the hardware accelerator in the target collocation scheme is updated to be an in use state, and the image is inferred according to the target collocation scheme. When the inferring of the image is completed, the usage state of the hardware accelerator is updated from the in use state to be the idle state. Once an actual time duration of inferring the image is obtained, the estimated time duration is updated to be the actual time duration.

### FIELD

The present disclosure relates to image processing technologies, in particular to an image inference method, a computer device, and a storage medium.

### BACKGROUND

Generally, a deep learning model is trained under a machine learning framework and a hardware accelerator acting jointly. However, for an application scenario that requires frequently performing inference on images, it is very difficult to quickly respond to requirements using the trained deep learning model. Existing inference methods cannot achieve performing inferences at high speed and do not meet requirements of high speed productions.

### BRIEF DESCRIPTION OF THE DRAWINGS

FIG. 1 is a flowchart of a method for inferring an image provided by an embodiment of the present disclosure.

FIG. 2 is an example of a preset weight table provided by an embodiment of the present disclosure.

FIG. 3 is a structural diagram of a computer device provided by an embodiment of the present disclosure.

FIG. 4 is a block diagram of an image inference system provided by an embodiment of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

At block S1, the computer device receives an inference request for inferring an image, and detects whether the inference request is correct.

In one embodiment, the inferring of the image may refer to detect defect in the image, recognizing one or more objects from the image, or other operation should be performed on the image.

In one embodiment, information contained in the inference request includes, but is not limited to, the image, a name of a neural network required to infer the image, and a format of the image.

In one embodiment, the computer device detects whether the inference request is correct by:
Performing a first detection by confirming whether the inference request contains the image, the name of the neural network required to infer the image, and the format of the image (e.g., an image matrix format);
Performing a second detection by detecting the format of the image, and confirming whether the detected format is consistent with the format of the image contained in the inference request;
Performing a third detection by confirming whether the name of the neural network contained in the inference request is applicable to the image; and
Confirming that the inference request is correct when detection results of the first detection, the second detection and/or the third detection meet corresponding conditions. In other words, the computer device can determine that the inference request is correct when the inference request contains the image, contains the name of the neural network required to infer the image; contains the format of the image; the detected format being consistent with the format of the image contained in the inference request; and/or the name of the neural network contained in the inference request being applicable to the image.

In one embodiment, the computer device pre-trains a plurality of neural network models, and each of the plurality of neural network models corresponds to a name. For example, a neural network model used for defect detection is named “Defect detection_A”. The plurality of neural network models may also include image recognition models. The image recognition model may be a neural network model that recognizes objects (e.g., people, characters, etc.) in images. In other embodiments, the plurality of neural network models may further include an image localization model, an image collocation model, and the like.

It should be noted that the inference request may further include a request for detecting defects appearing in the image, a request for recognizing the image, and the like.

In one embodiment, if the detection results of the first detection, the second detection and the third detection do not meet the corresponding conditions, the computer device confirms that the inference request is wrong, and receives an updated inference request until an inference request received by the computer device is found to be correct. The computer device performs subsequent blocks on the basis of a correct inference request.

At block S2, when the inference request is correct, the computer device determines a target collocation scheme for the image according to the inference request and a preset weight table, the target collocation scheme includes a hardware accelerator in an idle state and an estimated time duration of inferring the image.

In one embodiment, the preset weight table includes: a name of each of a plurality of hardware accelerators (for example, CPU, GPU, TPU, VPU, etc.), a current usage state of each hardware accelerator, and a name of each of a plurality of machine learning frameworks (for example, Tensorflow, OpenVINO, PyTorch, ONNX, etc.) supported by each hardware accelerator, a name of each of a plurality of neural networks loaded by each hardware accelerator, and an estimated time duration of each neural network loaded by each hardware accelerator, wherein the usage state of each hardware accelerator may be an in use state or an idle state. For example, as shown in FIG. 2, an example of a preset weight table provided by an embodiment of the present disclosure is shown.

In one embodiment, the determining of the target collocation scheme for the image according to the inference request and the preset weight table includes:
Confirming first hardware accelerators each of which is in idle state from the plurality of hardware accelerators;
Obtaining a plurality of collocation schemes by exhausting combinations of each of the first hardware accelerators, each of the plurality of machine learning frameworks, and each of the plurality of neural networks;
Obtaining an estimated time duration for each of the plurality of collocation schemes according to the preset weight table (for example, calculating an estimated time duration for a first collocation scheme to be 0.5 seconds, the first collocation scheme refers to a collocation of the hardware accelerator “VPU”, the machine learning framework OpenVINO and the neural network “Defect Detection_A”);
Selecting collocation schemes which are suitable for the image from the plurality of collocation schemes according to the inference request; and
From the collocation schemes which are suitable for the image, determining a collocation scheme corresponding to a shortest estimated time duration as being the target collocation scheme.

In other embodiments, the computer device may obtain a plurality of collocation schemes by exhaust all combinations of each of the plurality of hardware accelerators, each of the plurality of machine learning frameworks, and each of the plurality of neural networks; obtain the estimated time duration of each of the plurality of collocation schemes; save the plurality of collocation schemes; when the inference request for inferring an image is correct, select first collocation schemes each of which including a hardware accelerator in idle state from the plurality of collocation schemes; select second collocation schemes suitable for the image from the first collocation schemes; and determine a collocation scheme corresponding to a shortest estimated time duration from the second collocation schemes as the target collocation scheme.

In other embodiments, each of the plurality of collocation schemes may include more than one hardware accelerators, and the more than one hardware accelerators can parallelly perform inference on the image. Accordingly, the target collocation scheme may include more than one hardware accelerators, and the more than one hardware accelerators can parallelly perform inference on the image, thereby further improving, the efficiency of inferring, an image.

In one embodiment, when there is no hardware accelerator in idle state during the calculation of the target collocation scheme, the computer device further suspends the calculation of the target collocation scheme until there is at least one hardware accelerator in idle state. It should be noted that the usage state of the hardware accelerator mentioned at block S4 will be updated to be idle state after the inference of the image is completed.

At block S3, the computer device updates a usage state of the hardware accelerator included in the target collocation scheme from the idle state to be an in use state, and infers the image according to the target collocation scheme.

In one embodiment, the inferring of the image according to the target collocation scheme includes:
Determining a format required by the machine learning framework included in the target collocation scheme;
Obtaining a converted image by converting the format of the image into the required format, and inferring the converted image by using the neural network included in the target collocation scheme.

For example, when the target collocation scheme indicates that the hardware accelerator is VPU, the machine learning framework is OpenVINO and the neural network is “Defect Detection_A”, the computer device first updates the usage state of the VPU to be the in use state, and converts the format of the image from the matrix format to be the format (for example, binarize the image) required by OpenVINO, and then perform defect detection on the converted image by using “Defect Detection_A”.

At block S4, when the inferring of the image is completed, the computer device updates the usage state of the hardware accelerator included in the target collocation scheme from the in use state to be the idle state, obtains an actual time duration of inferring the image, and updates the estimated time duration included in target collocation scheme to be the actual time duration when the estimated time duration is not equal to the actual time duration.

In one embodiment, the actual time duration of inferring the image refers to a time duration between a first time point and a second time point. The first time point is a time point that the computer device begins to determine the required format, and the second time point refers to a time point that the computer device obtains a result of inferring the image. It should be noted that the first time point and the second time point can be defined to be other suitable time points. In one embodiment, it is assumed that the target collocation scheme indicates that the hardware accelerator is “WU”, and the machine teaming framework is “OpenVINO” and the neural network is “Defect Detection_A”, and the target collocation scheme indicates that the estimated time duration equals 0.5 seconds, if the actual time duration of inferring the image equals 0.4 seconds which is different from the estimated time duration, the computer device updates the estimated time duration of the target matching scheme to be the actual time duration i.e., 0.4 seconds, so as to provide a more accurate estimated time duration for a next use of this target collocation scheme.

The inference efficiency improvement method provided by this disclosure is aimed at the production field with the demand for prediction speed, and can make full use of all software and hardware resources, break through the limitation of a single hardware with a single machine learning framework, and maximize the use of software and hardware resources, which improves the prediction throughput of inference while maintaining the advantages of each machine learning framework. It can also dynamically update the actual time duration of inferring an image, effectively improving the inference efficiency of images.

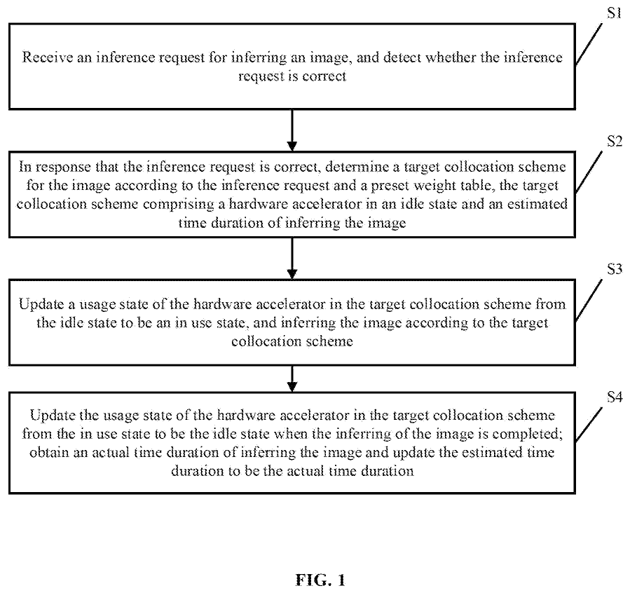

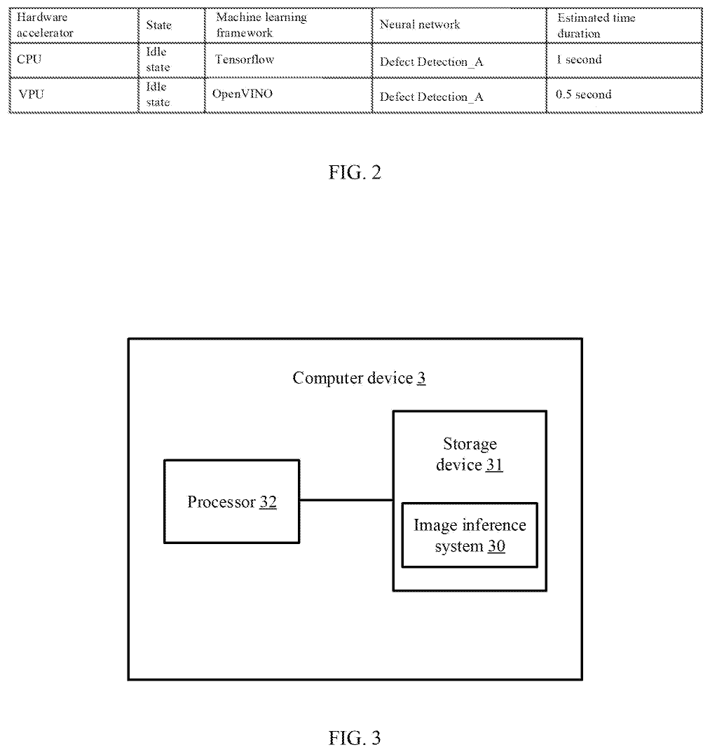

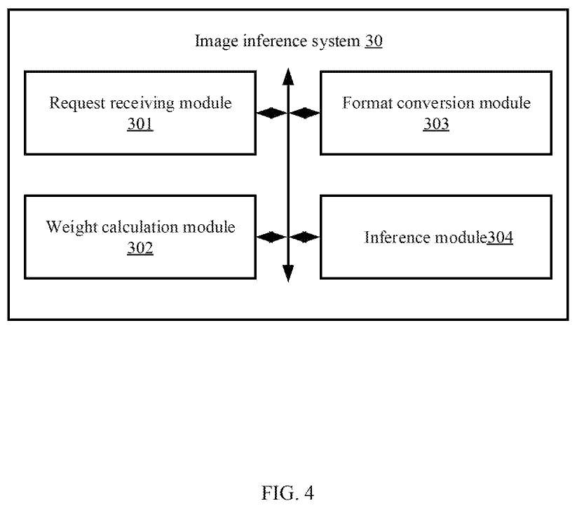

FIG. 1 describes in detail the method for matching image features of the present disclosure. Hardware architecture that implements the method for matching image features is described in conjunction with FIG. 3 and FIG. 4.

It should be understood that the described embodiments are for illustrative purposes only, and are not limited by this structure in the scope of the claims.

FIG. 3 is a block diagram of a computer device provided by the present disclosure. The computer device 3 may include a storage device 31 and at least one processor 32. It should be understood by those skilled in the art that the structure of the computer device 3 shown in FIG. 3 does not constitute a limitation of the embodiment of the present disclosure. The computer device 3 may further include other hardware or software, or the computer device 3 may have different component arrangements.

In at least one embodiment, the computer device 3 may include a terminal that is capable of automatically performing numerical calculations and/or information processing in accordance with pre-set or stored instructions. The hardware of terminal can include, but is not limited to, a microprocessor, an application specific integrated circuit, programmable gate arrays, digital processors, and embedded devices.

It should be noted that the computer device 3 is merely an example, and other existing or future electronic products may be included in the scope of the present disclosure, and are thus included in the reference.

In some embodiments, the storage device 31 can be used to store program codes of computer readable programs and various data, such as an image inference system 30 installed in the computer device 3, and automatically access the programs or data with high speed during the running of the computer device 3. The storage device 31 can include a read-only memory (ROM), a random access memory (RAM), a programmable read-only memory (PROM), an erasable programmable read only memory (EPROM), an one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the computer device 3 that can be used to carry or store data.

In some embodiments, the at least one processor 32 may be composed of an integrated circuit, for example, may be composed of a single packaged integrated circuit, or multiple integrated circuits of same function or different functions. The at least one processor 32 can include one or more central processing units (CPU), a microprocessor, a digital processing chip, a graphics processor, and various control chips. The at least one processor 32 is a control unit of the computer device 3, which connects various components of the computer device 3 using various interfaces and lines. By running or executing a computer program or modules stored in the storage device 31, and by invoking the data stored in the storage device 31, the at least one processor 32 can perform various functions of the computer device 3 and process data of the computer device 3. For example, the processor 32 may perform the function of inferring an image shown in FIG. 1 to improve an inference efficiency.

In some embodiments, the image inference system 30 operates in computer device 3. The image inference system 30 may include a plurality of functional modules composed of program code segments. The program code of each program segment in the image inference system 30 can be stored in storage device 31 of the computer device 3 and executed by at least one processor 32 to achieve blocks of method as shown in FIG. 1.

In this embodiment, the image inference system 30 can be divided into a plurality of functional modules. For example, the image inference system 30 can include a request receiving module 301, a weight calculation module 302, a format conversion module 303, and an inference module 304. The “Module” means a series of computer program segments that can be executed by at least one processor 32 and perform fixed functions and are stored in storage device 31.

In one embodiment, the request receiving module 301 receives the inference request for inferring the image, and detects whether the inference request is correct. When the inference request is correct, the request receiving module 301 sends the inference request to the weight calculation module 302; the weight calculation module 302 determines the target collocation scheme for the image according to the inference request and the preset weight table, the weight calculation module 302 updates the usage state of the hardware accelerator in the target collocation scheme from the idle state to be the in use state; the weight calculation module 302 sends the inference request and the target collocation scheme to the format conversion module 303; the format conversion module 303 determines the format required by the machine learning framework comprised in the target collocation scheme; and obtains the converted image by converting the format of the image into the required format; the format conversion module 303 sends the converted image and the target collocation scheme to the inference module 304, and the inference module 304 infers the converted image by using the neural network comprised in the target collocation scheme. When the inferring of the image is completed, the inference module 304 updates the usage state of the hardware accelerator in the target collocation scheme from the in the use state to be the idle state, and obtains the actual time duration of inferring the image, and updates the estimated time duration to be the actual time duration.

The program codes are stored in storage device 31 and at least one processor 32 nay invoke the program codes stored in storage device 31 to perform the related function. The program codes stored in the storage device 31 can be executed by at least one processor 32, so as to realize the function of each module to achieve the purpose of matching image features as shown in FIG. 1.

In one embodiment of this application, said storage device 31 stores at least one instruction, and said at least one instruction is executed by said at least one processor 32 for the purpose of matching image features as shown in FIG. 1.

Although not shown, the computer device 3 may further include a power supply (such as a battery) for powering various components. Preferably, the power supply may be logically connected to the at least one processor 32 through a power management device, thereby, the power management device manages functions such as charging, discharging, and power management. The power supply may include one or more DC or AC power sources, a recharging device, a power failure detection circuit, a power converter or inverter, a power status indicator, and the like. The computer device 3 may further include various sensors, such as a BLUETOOTH module, a WI-FI module, and the like, and details are not described herein.

In the several embodiments provided in this disclosure, it should be understood that the devices and methods disclosed can be implemented by other means. For example, the device embodiments described above are only schematic. For example, the division of the modules is only a logical function division, which can be implemented in another way.

The modules described as separate parts may or may not be physically separate, and the parts displayed as modules may or may not be physical units, that is, may be located in one place, or may be distributed over multiple network units. Part or all of the modules can be selected according to the actual needs to achieve the purpose of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The above integrated modules implemented in the form of function modules may be stored in a storage medium. The above function modules may be stored in a storage medium, and include several instructions to enable a computing device (which may be a personal computer, server, or network device, etc.) or processor to execute the method described in the embodiment of the present disclosure.

The present disclosure is not limited to the details of the above-described exemplary embodiments, and the present disclosure can be embodied in other specific forms without departing, from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but not to signify any particular order.

The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. An image inference method applied to a computer device, the method comprising:
receiving an inference request for inferring an image, and detecting whether the inference request is correct;
in response that the inference request is correct, determining a target collocation scheme for the image according to the inference request and a preset weight table, the target collocation scheme comprising a hardware accelerator in an idle state and an estimated time duration of inferring the image;
updating a usage state of the hardware accelerator in the target collocation scheme from the idle state to be an in use state, and inferring the image according to the target collocation scheme;
when the inferring of the image is completed, updating the usage state of the hardware accelerator in the target collocation scheme from the in use state to be the idle state; and
obtaining an actual time duration of inferring the image, and updating the estimated time duration to be the actual time duration.

2. The image inference method according to claim 1, wherein information contained in the inference request comprises the image, a name of a neural network required to infer the image, and a format of the image.

3. The image inference method according to claim 2, wherein detecting whether the inference request is correct comprises:
performing a first detection by confirming whether the inference request contains the image, the name of the neural network required to infer the image, and the format of the image;
performing a second detection by detecting a format of the image, and confirming whether the detected format is consistent with the format of the image contained in the inference request;
performing a third detection by confirming whether the name of the neural network contained in the inference request is applicable to the image; and
confirming that the inference request is correct when detection results of the first detection, the second detection and/or the third detection meet corresponding conditions.

4. The image inference method according to claim 1, wherein the preset weight table comprises a name of each of a plurality of hardware accelerators, a current usage state of each hardware accelerator, and a name of each of a plurality of machine learning frameworks supported by each hardware accelerator, a name of each of a plurality of neural networks loaded by each hardware accelerator, and an estimated time duration of each neural network loaded by each hardware accelerator, a usage state of each hardware accelerator being an in use state or the idle state.

5. The image inference method according to claim 4, wherein determining the target collocation scheme for the image according to the inference request and the preset weight table comprises:
confirming first hardware accelerators each of which is in idle state from the plurality of hardware accelerators;
obtaining a plurality of collocation schemes by exhausting combinations of each of the first hardware accelerators, each of the plurality of machine learning frameworks, and each of the plurality of neural networks;
obtaining an estimated time duration for each of the plurality of collocation schemes according to the preset weight table;
selecting collocation schemes which are suitable for the image from the plurality of collocation schemes according to the inference request; and
from the collocation schemes which are suitable for the image, determining a collocation scheme corresponding to a shortest estimated time duration as being the target collocation scheme.

6. The image inference method according to claim 5, wherein inferring of the image according to the target collocation scheme comprises:
determining a format required by the machine learning framework comprised in the target collocation scheme; and
obtaining a converted image by converting the format of the image into the required format, and inferring the converted image by using the neural network comprised in the target collocation scheme.

7. The image inference method according to claim 1, further comprising:
when there is no hardware accelerator in idle state during the calculation of the target collocation scheme, suspending the calculating of the target collocation scheme until there is at least one hardware accelerator in idle state.

8. A computer device comprising:
a storage device;
at least one processor; and
the storage device storing one or more programs, which when executed by the at least one processor, cause the at least one processor to:
receive an inference request for inferring an image, and detect whether the inference request is correct;
in response that the inference request is correct, determine a target collocation scheme for the image according to the inference request and a preset weight table, the target collocation scheme comprising a hardware accelerator in an idle state and an estimated time duration of inferring the image;
update a usage state of the hardware accelerator in the target collocation scheme from the idle state to be an in use state, and inferring the image according to the target collocation scheme;
when the inferring of the image is completed, update the usage state of the hardware accelerator in the target collocation scheme from the in use state to be the idle state;
obtain an actual time duration of inferring the image, and update the estimated time duration to be the actual time duration.

9. The computer device according to claim 8, wherein information contained in the inference request comprises the image, a name of a neural network required to infer the image, and a format of the image.

10. The computer device according to claim 9, wherein the at least one processor detects whether the inference request is correct by:
performing a first detection by confirming whether the inference request contains the image, the name of the neural network required to infer the image, and the format of the image;
performing a second detection by detecting a format of the image, and confirming whether the detected format is consistent with the format of the image contained in the inference request;
performing a third detection by confirming whether the name of the neural network contained in the inference request is applicable to the image; and
confirming that the inference request is correct when detection results of the first detection, the second detection and/or the third detection meet corresponding conditions.

11. The computer device according to claim 8, wherein the preset weight table comprises a name of each of a plurality of hardware accelerators, a current usage state of each hardware accelerator, and a name of each of a plurality of machine learning frameworks supported by each hardware accelerator, a name of each of a plurality of neural networks loaded by each hardware accelerator, and an estimated time duration of each neural network loaded by each hardware accelerator, a usage state of each hardware accelerator being an in use state or the idle state.

12. The computer device according to claim 11, wherein the at least one processor determines the target collocation scheme for the image according to the inference request and the preset weight table by:
confirming first hardware accelerators each of which is in idle state from the plurality of hardware accelerators;
obtaining a plurality of collocation schemes by exhausting combinations of each of the first hardware accelerators, each of the plurality of machine learning frameworks, and each of the plurality of neural networks;
obtaining an estimated time duration for each of the plurality of collocation schemes according to the preset weight table;
selecting collocation schemes which are suitable for the image from the plurality of collocation schemes according to the inference request; and
from the collocation schemes which are suitable for the image, determining a collocation scheme corresponding to a shortest estimated time duration as being the target collocation scheme.

13. The computer device according to claim 12, wherein the at least one processor infers the image according to the target collocation scheme by:
determining a format required by the machine learning framework comprised in the target collocation scheme; and
obtaining a converted image by converting the format of the image into the required format, and inferring the converted image by using the neural network comprised in the target collocation scheme.

14. The computer device according to claim 8, wherein the at least one processor is further caused to:
when there is no hardware accelerator in idle state during the calculation of the target collocation scheme, suspend the calculating of the target collocation scheme until there is at least one hardware accelerator in idle state.

15. A non-transitory storage medium having stored thereon at least one computer-readable instructions, which when executed by a processor of a computer device, causes the processor to perform an image inference method, wherein the method comprises:
receiving an inference request for inferring an image, and detecting whether the inference request is correct;
in response that the inference request is correct, determining a target collocation scheme for the image according to the inference request and a preset weight table, the target collocation scheme comprising a hardware accelerator in an idle state and an estimated time duration of inferring the image;
updating a usage state of the hardware accelerator in the target collocation scheme from the idle state to be an in use state, and inferring the image according to the target collocation scheme;
when the inferring of the image is completed, updating the usage state of the hardware accelerator in the target collocation scheme from the in use state to be the idle state;
obtaining an actual time duration of inferring the image, and updating the estimated time duration to be the actual time duration.

16. The non-transitory storage medium according to claim 15, wherein information contained in the inference request comprises the image, a name of a neural network required to infer the image, and a format of the image.

17. The non-transitory storage medium according to claim 16, wherein detecting whether the inference request is correct comprises:
performing a first detection by confirming whether the inference request contains the image, the name of the neural network required to infer the image, and the format of the image;
performing a second detection by detecting a format of the image, and confirming whether the detected format is consistent with the format of the image contained in the inference request;
performing a third detection by confirming whether the name of the neural network contained in the inference request is applicable to the image; and
confirming that the inference request is correct when detection results of the first detection, the second detection and/or the third detection meet corresponding conditions.

18. The non-transitory storage medium according to claim 15, wherein the preset weight table comprises a name of each of a plurality of hardware accelerators, a current usage state of each hardware accelerator, and a name of each of a plurality of machine learning frameworks supported by each hardware accelerator, a name of each of a plurality of neural networks loaded by each hardware accelerator, and an estimated time duration of each neural network loaded by each hardware accelerator, a usage state of each hardware accelerator being an in use state or the idle state.

19. The non-transitory storage medium according to claim 18, wherein determining the target collocation scheme for the image according to the inference request and the preset weight table comprises:
confirming first hardware accelerators each of which is in idle state from the plurality of hardware accelerators;
obtaining a plurality of collocation schemes by exhausting combinations of each of the first hardware accelerators, each of the plurality of machine learning frameworks, and each of the plurality of neural networks;
obtaining an estimated time duration for each of the plurality of collocation schemes according to the preset weight table;
selecting collocation schemes which are suitable for the image from the plurality of collocation schemes according to the inference request; and
from the collocation schemes which are suitable for the image, determining a collocation scheme corresponding to a shortest estimated time duration as being the target collocation scheme.

20. The non-transitory storage medium according to claim 19, wherein inferring of the image according to the target collocation scheme comprises:
determining a format required by the machine learning framework comprised in the target collocation scheme; and
obtaining a converted image by converting the format of the image into the required format, and inferring the converted image by using the neural network comprised in the target collocation scheme.
